(19) United States
(12) Patent Application Publication
(10) Pub. No.: US 2025/0242386 A1
(43) Pub. Date: Jul. 31, 2025

(54) Cartridge Shell Casing Collection Device

(71) Applicant: Beau Jonathon Storm Machat, Barrie (CA)

(72) Inventor: Beau Jonathon Storm Machat, Barrie (CA)

(21) Appl. No.: 18/951,810

(22) Filed: Nov. 19, 2024

Related U.S. Application Data
(60) Provisional application No. 63/625,584, filed on Jan. 26, 2024.

(51) Int. Cl. B08B 1/16; B08B 1/30; F41A 9/60

(52) U.S. Cl. CPC B08B 1/165; B08B 1/30; F41A 9/60

(57) ABSTRACT

A collector device includes a bin structure defining a chamber for storing the cartridge shell casings with an entrance opening defined at a first end for receiving the cartridge shell casings picked from the surface. The collector device also includes a lip coupled to the bin structure and extending outwardly from the entrance opening and configured to pick the cartridge shell casings from the surface. Moreover, the collector device includes a pair of wheels movably coupled to the bin structure to support and move the bin structure on the surface. Further, the collector device includes at least one auger coupled to the wheels and arranged to rotate in response to the rotation of the wheels on the surface. The at least one auger partially overlaps the lip and configured to push the cartridge shell casings, picked by the lip, inside the bin structure.

### BACKGROUND OF THE INVENTION

### Technical Field

The present disclosure relates, generally, to a collector device for picking and collecting cartridge casings from a ground, and more particularly to a collector device configured to move over a surface and pick and collect the cartridge casings while moving on the surface.

### Description of the Prior Art

A cartridge is a unit of ammunition, made up of a cartridge shell casing that has a bullet, a gunpowder and a primer inside of it. Cartridge is used for a gun, a pistol and a rifle used in various activities, like training courses for military troops, shooting practice sessions and competitions. During shooting, generally, the shell casings are randomly scattered on a shooting field. It is very difficult and time-consuming to manually recover the large quantity of the cartridge shell casings from the scattered positions.

### SUMMARY OF THE INVENTION

According to an aspect of the disclosure, a collector device for picking and collecting cartridge shell casings from a surface is disclosed. The collector device includes a bin structure defining a chamber for storing the cartridge shell casings with an entrance opening defined at a first end for receiving the cartridge shell casings picked from the surface. The collector device also includes a lip coupled to the bin structure and extending outwardly from the entrance opening and configured to pick the cartridge shell casings from the surface. Moreover, the collector device includes a pair of wheels movably coupled to the bin structure to support and move the bin structure on the surface. Further, the collector device includes at least one auger coupled to the wheels and arranged to rotate in response to the rotation of the wheels on the surface. The at least one auger partially overlaps the lip and configured to push the cartridge shell casings, picked by the lip, inside the bin structure.

In some additional, alternative, or selectively cumulative embodiments, the bin structure defines an opening arranged proximate to a second end of the bin structure to enable a removal of the cartridge shell casings from the chamber.

In some additional, alternative, or selectively cumulative embodiments, the opening is defined between a sidewall of the bin structure and a lid of the bin structure arranged to cover the chamber from top.

In some additional, alternative, or selectively cumulative embodiments, the opening is defined between a rear wall of the bin structure and a lid of the bin structure arranged to cover the chamber from top.

In some additional, alternative, or selectively cumulative embodiments, the bin structure includes a base defining a plurality of openings to enable a removal of the dirt from the chamber.

In some additional, alternative, or selectively cumulative embodiments, the collector device includes a pair of extender walls extending outwardly of the first end of the bin structure. The lip is arranged between the extender walls and the pair of wheels are rotatably coupled to extender walls.

In some additional, alternative, or selectively cumulative embodiments, the collector device comprises a pair of protrusion tabs arranged forwardly of the pair of wheels and connected to the pair of extender walls.

In some additional, alternative, or selectively cumulative embodiments, the lip includes a tip portion adapted to contact and lift the cartridge shell casings, and a curved surface to facilitate the at least one auger to transport the picked cartridge shell casings to the chamber.

In some additional, alternative, or selectively cumulative embodiments, the bin structure includes a rear wall arranged opposite to the entrance opening and defining a chute to facilitate a removal of the collected cartridge shell casings from the chamber.

In some additional, alternative, or selectively cumulative embodiments, the at least one auger includes a pair of augers engaged to the pair of wheels.

In some additional, alternative, or selectively cumulative embodiments, each of the pair of wheels includes an engagement structure, and each of the pair of augers includes a retention structure engaged to the engagement structure, coupling the pair of augers with the pair of wheels.

In some additional, alternative, or selectively cumulative embodiments, the engagement structure includes a plurality of protrusions and the retention structure includes a plurality of slots to receive the plurality of protrusions.

In some additional, alternative, or selectively cumulative embodiments, the engagement structure includes a first square hole and the retention structure includes a second square hole arranged aligned with the first square hole and a pin extends inside the aligned first and second square holes, engaging the wheel with the auger.

In some additional, alternative, or selectively cumulative embodiments, the collector device comprises a handle coupled to the bin structure to enable a user to hold the collector device and move the collector device on the surface to pick the cartridge shell casings from the surface.

In some additional, alternative, or selectively cumulative embodiments, the collector device comprises a handle engagement structure attached to the bin structure, wherein the handle is removably engaged to the handle engagement structure.

In some additional, alternative, or selectively cumulative embodiments, the handle engagement structure includes a tube portion coupled to the bin structure to removably receive the handle.

In some additional, alternative, or selectively cumulative embodiments, the handle engagement structure includes a rod attached to the bin structure and the tube portion is pivotally engaged with the rod and configured to pivot about at least one axis relative to the rod.

In some additional, alternative, or selectively cumulative embodiments, wherein the at least one axis includes a first axis and a second axis extending perpendicularly to the first axis.

In some additional, alternative, or selectively cumulative embodiments, the handle is a telescopic handle and includes a pin structure adapted to be inserted inside a lid of the bin structure to secure the handle in a retracted position.

In some additional, alternative, or selectively cumulative embodiments, the bin structure includes a pair of sidewalls and a pair of fingers extending outwardly of the chamber in the lateral direction to pry out buried cartridge shell casings.

### BRIEF DESCRIPTION OF FIGURES

FIG. 1 illustrates a top perspective view of a collector device, in accordance with an embodiment of the disclosure;

FIG. 2 illustrates a bottom perspective view of the collector device of FIG. 1, in

accordance with an embodiment of the disclosure;

FIG. 3 illustrates an exploded view of the collector device of FIG. 1, in accordance with an embodiment of the disclosure;

FIG. 4 illustrates a sectional perspective view of the collector device of FIG. 1 depicting a cartridge shell casing being picked and thrown inside a chamber, in accordance with an embodiment of the disclosure;

FIG. 5 illustrates a perspective view of a collector device having a handle, in an accordance with an embodiment of the disclosure;

FIG. 6 illustrates a perspective view of the collector device of FIG. 5 without the handle and a lid of a bin structure of the collector device, in accordance with an embodiment of the disclosure;

FIG. 7 illustrates a top perspective view of a portion of the collector device of FIG. 5 with wheels and augers of the collector device removed, in accordance with an embodiment of the disclosure;

FIG. 8 is a side perspective view of the portion of the collector device of FIG. 7, in accordance with an embodiment of the disclosure;

FIG. 9 is a front perspective view of a portion of the collector device of FIG. 5 depicting a space defined between an extender wall and a lip of the collector device with one wheel arranged inside the space, in accordance with an embodiment of the disclosure;

FIG. 10 is sectional side perspective view of the collector device of FIG. 5 depicting an arrangement of the auger and lip and structural details of the lip, in accordance with an embodiment of the disclosure;

FIG. 11 illustrates the wheel and the auger disengaged from the wheel, in accordance with an embodiment of the disclosure;

FIG. 12 illustrates a top side perspective view of a collector device with a handle extending in a first direction, in accordance with an embodiment of the disclosure;

FIG. 13 illustrates a rear perspective view of the collector device of FIG. 12 depicting the handle extending in a second direction, in accordance with an embodiment of the disclosure;

FIG. 14 illustrates a front view of the collector device of FIG. 12, in accordance with an embodiment of the disclosure;

FIG. 15 illustrates a front perspective of a lip of the collector device of FIG. 12, in accordance with an embodiment of the disclosure;

FIG. 16 illustrates a sectional side perspective view of a portion of the collector device of FIG. 12 depicting a relative arrangement of a wheel, an auger, and lip of the collector device of FIG. 12, in accordance with an embodiment of the disclosure;

FIG. 17 is a sideview of a bottom portion of the section shown in FIG. 16, in accordance with an embodiment of the disclosure.

FIG. 18 illustrates the wheel, the auger disengaged from the wheel, a pin that connects the auger to the wheel of the collector device of FIG. 12, in accordance with an embodiment of the disclosure;

FIG. 19 illustrates a bottom front perspective view of a portion of the collector device of FIG. 12 depicting a protrusion tab arranged in front of wheel, in accordance with an embodiment of the disclosure;

FIG. 20 illustrates a top view of the portion of the collector device shown in FIG. 19, in accordance with an embodiment of the disclosure; and

FIG. 21 depicts a pin structure extended inside a lid of a bin structure in a retracted position of the handle to secure the handle in the retracted position, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” “left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

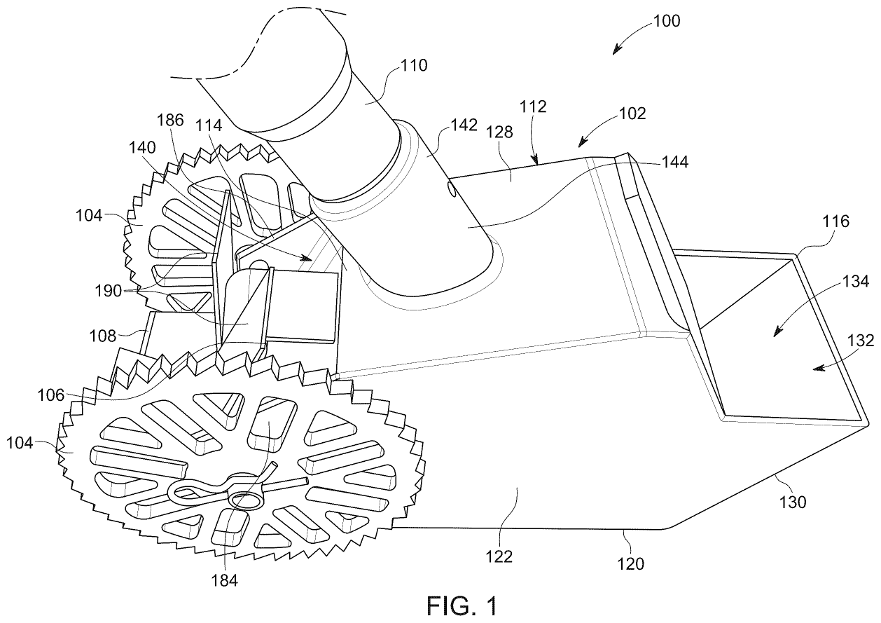

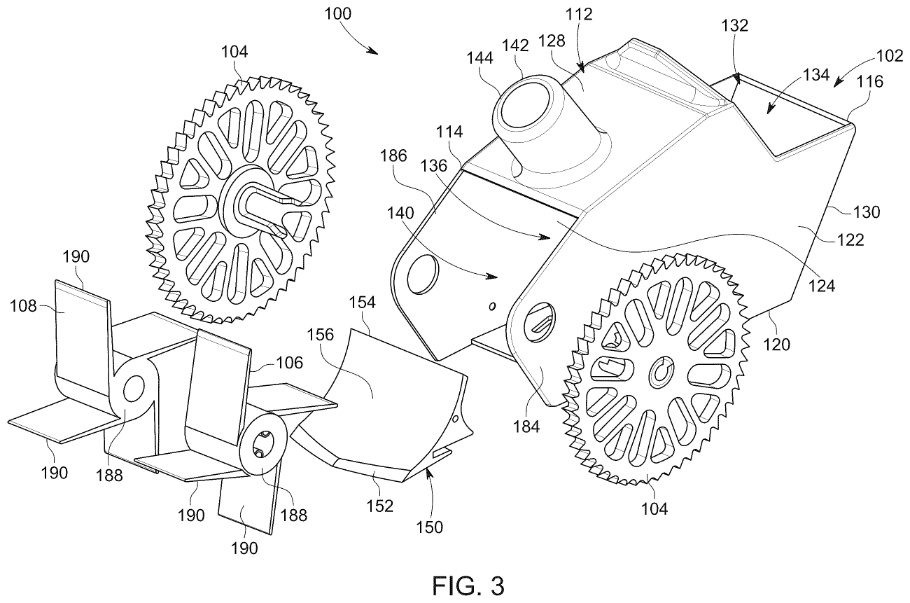

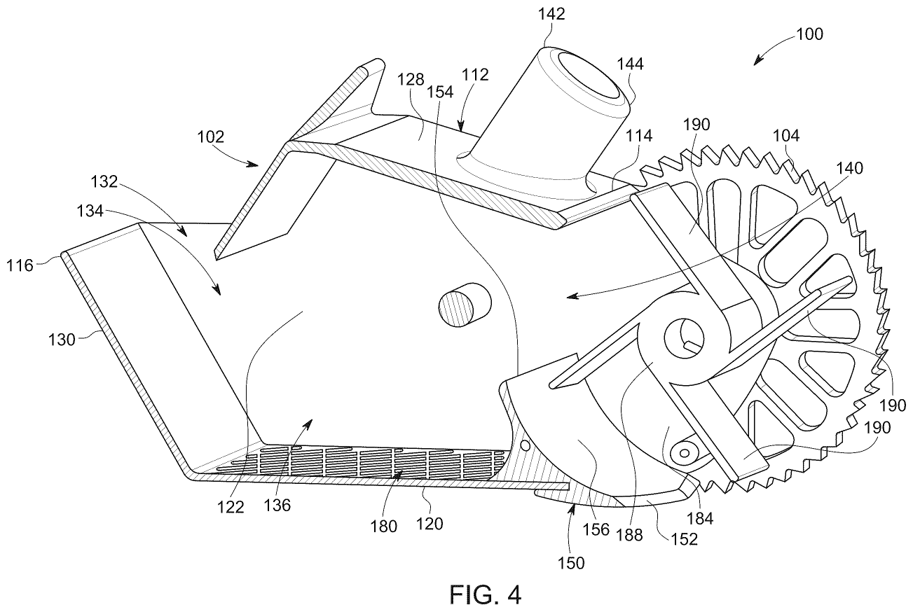

Referring to FIGS. 1 to 4, a collector device 100 for picking and collecting cartridge shell casings (hereinafter referred to as casings) from a ground or a surface is disclosed. The collector device 100 includes a collector 102 and a pair of wheels 104 movably supporting the collector on the surface, for example, the ground, and arranged to facilitate a movement of the collector device 100 over the surface. The collector device 100 also includes at least one auger, for example, two augers 106, 108 coupled to the wheels 104 to pick and push the picked casings inside the collector 102, and a handle 110 to push and move the collector device 100 on the surface.

As shown, the collector 102 includes a bin structure 112 having a first end 114, a second end 116, a base 120 extending from the first end 114 to the second end 116, and a pair of sidewalls 122, 124 extending vertically upwardly from the base 120 and arranged spaced apart from each other. The pair of sidewalls 122, 124 extends from the first end 114 to the second end 116 in a longitudinal direction of the collector device 100. The bin structure 112 also includes a roof 128 i.e., lid 128 arranged spaced apart from the base 120 and supported on the sidewalls 122, 124. The roof 128 is integrally formed with the sidewalls 122, 124. Moreover, the bin structure 120 includes a rear wall 130 extending vertically from the base 120 towards the roof 128 and defining a rear opening 132 therebetween which is arranged proximate to the roof 128. As shown, the rear wall extends obliquely outwardly from the base 120, and therefore a chute 134 that is arranged at rear of the bin structure 112 with the rear opening 132 defining an opening of the chute 134 to facilitate a removal of the collected casings stored inside a chamber 136 of the bin structure 112.

Further, the bin structure 112 defines an entrance opening 140 at the first end 114 to allow an entry of the casings inside the bin structure 112. Furthermore, the bin structure 112 includes a handle engagement structure 142 having a tube portion 144 extending obliquely from the roof 128 to enable a removable engagement of the handle 110 and to facilitate a picking of the bin structure 112 upon removal of the handle 110. The user picks the collector 102 by holding the tube portion 144 and transports it from one place to another place.

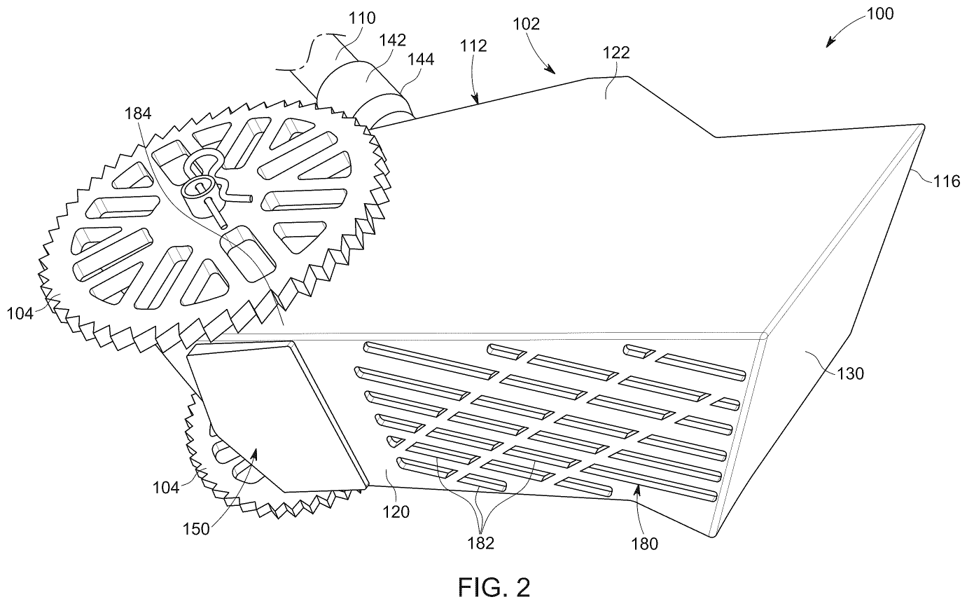

To facilitate picking of the casings from the ground, the collector 102 includes a lip 150 arranged at the first end 114 of the bin structure 112 and extending outwardly of the bin structure 112 and coupled to the base 120. In the illustrated embodiment, the lip 150 is removably coupled to the base 120. However, the lip 150 may be integrally formed with the base 120. As shown, the lip 150 includes a tip portion 152 configured to scrape along the surface to enable picking of the casings from the surface. The lip 150 includes a substantially arcuate shape with a rear edge 154 of the lip 150 arranged vertically offset from the tip portion 152 and is disposed rearwardly of the tip portion 152. Accordingly, the lip 150 includes a shape of a blade of a dozer or track type tractor, and the casings scrapped and picked by the tip portion 152 move along a curved surface 156 of the lip and is thrown inside the chamber 136. It may be appreciated that during scrapping of the casings from the ground or the surface, dirt and/or sand may also enter the chamber 136. Accordingly, to enable the disposal/removal of the dirt and sand from the chamber 136, the base 120 includes a mesh structure 180 defining a plurality of openings 182, shown in FIG. 2, to enable an exit and removal of the dirt and sand from the chamber 136.

To push the picked casings inside the chamber 136, the at least one auger, the augers 106, 108, is rotatably arrange at the first end 114 of the bin structure and extend partially outwardly of the entrance opening 140. In the illustrated embodiment, two augers 106, 108 are coupled to the wheels 104 via separate shafts such that augers 106, 108 rotates in response to the rotation of the associated wheel. The augers 106, 108 and the wheels 104 are between a pair of extender walls 184, 186 that extending outwardly, in the longitudinal direction, from the first end 114 of the bin structure 112, and are rotatably coupled to the pair of extender walls 184, 186. Accordingly, the wheels 104 rotate as the collector device 102 is pulled or pushed along the ground which in turn rotates the augers 106, 108. As shown, the wheels 104, 106 are arranged outside the bin structure 112. Further, each of the auger 104, 106 are identical in structure and assembly and includes a hub 188, and a plurality of blades 190 extending radially outwardly from an outer surface of the hub 188 and arrayed around a circumference of the hub. The blades 190 are adapted to contact the casings pickup by the lip 150 and push the casings along the curved surface 156, and transport the casings to the chamber 136.

To enable the user to push/move the collector device 100 along the surface, the handle is removably engaged with tube portion 144 and extends obliquely towards the front end 114 from the roof 128. In an embodiment, the handle 110 may is a telescopic handle configured to be extended and retracted. The handle 110 is retracted to reduce the length of the handle to enable an easy transportation of the collector device 100.

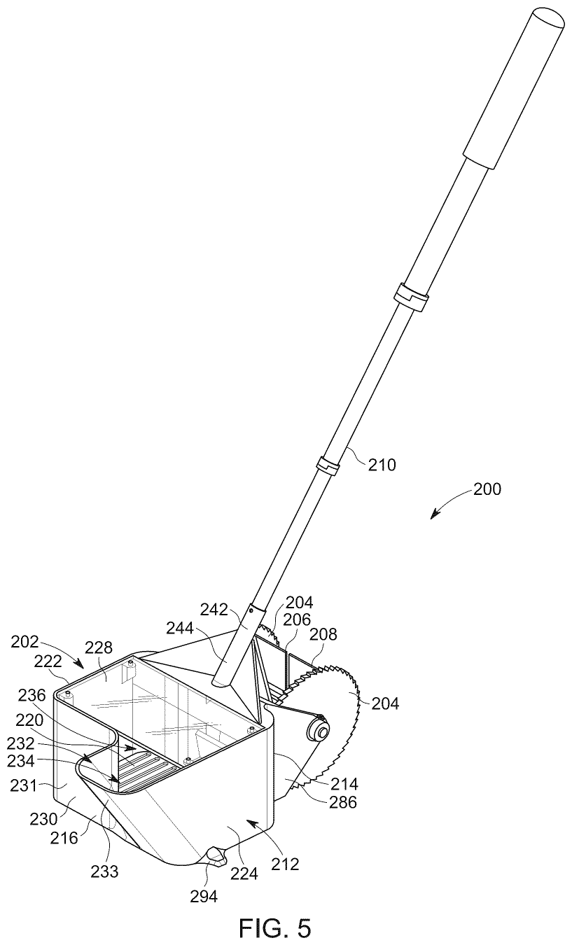

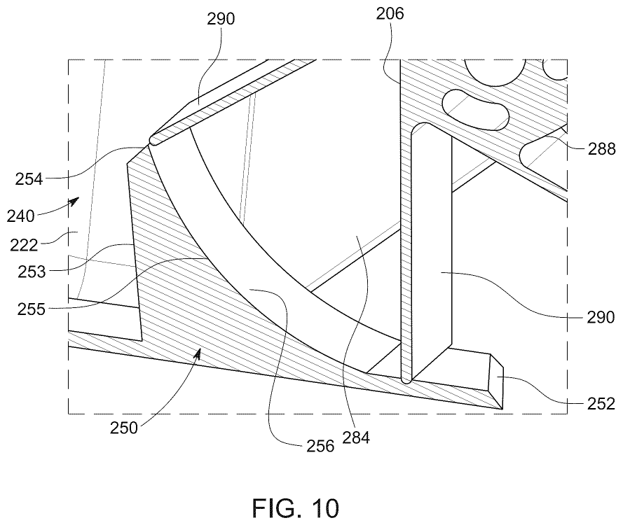

Referring to FIGS. 5 to 11, a collector device 200 is shown according to an alternative embodiment of the disclosure. The collector device 200 is suitable to be used at an outdoor location, and includes a collector 202, a handle 210, for example, a telescopic handle 210, removable coupled to the collector 202 to enable a user to operate the collector device 200, and a pair of wheels 204 rotatably coupled to the collector 202 and movably support the collector 200 on a surface. As shown, the collector 202 includes a bin structure 212 defining a chamber 236 to store casings picked up from the surface, a lip 250 coupled to the bin structure 212 to facilitate the picking and movement of the casings inside the bin structure 212 from the surface, and at least one auger, for example, two augers 206, 208 rotatably coupled to the bin structure 212 and configured to pick and transport the casings to the bin structure 212.

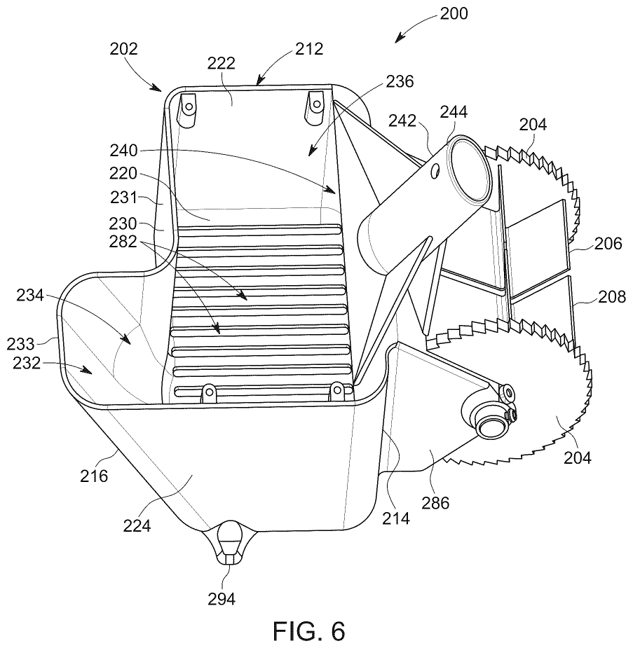

As shown in FIGS. 5 and 6, the bin structure 212 includes a first end 214, i.e., front end 214, a second end 216 i.e., a rear end 216 arranged opposite to the front end 214, a base 220 extending from the front end 214 to the rear end 216, and a pair of sidewalls 222, 224 extending vertically from the base 220 and arranged spaced apart and opposite to each other. The sidewalls 222, 224 extend from the from end 214 to the rear end 216 in a longitudinal direction and provides a support for a lid 228 i.e. roof 228 of the bin structure 212. The lid 228 may be fixedly or removably arranged on the upper ends of the sidewalls 222, 224, covering the bin structure 212 from top. Further, the bin structure 212 includes a rear wall 230 arranged at the rear end 216 and extending vertically from the base 220. As shown, the rear wall 230 extends in a lateral direction, connecting the pair of sidewalls 224, 226, and includes a first portion 231 and a second portion 233 that extends obliquely outwardly from the base 220 defining a chute 234. An opening 232 of the chute 234 is arranged at a top of the second portion 233 of the rear wall 230 between the lid 228 and an upper edge of the second portion 233 of the rear wall 228. The chute 234 facilitates a removal of the casings from the chamber 236 when the bin structure 212 is tilted downwardly.

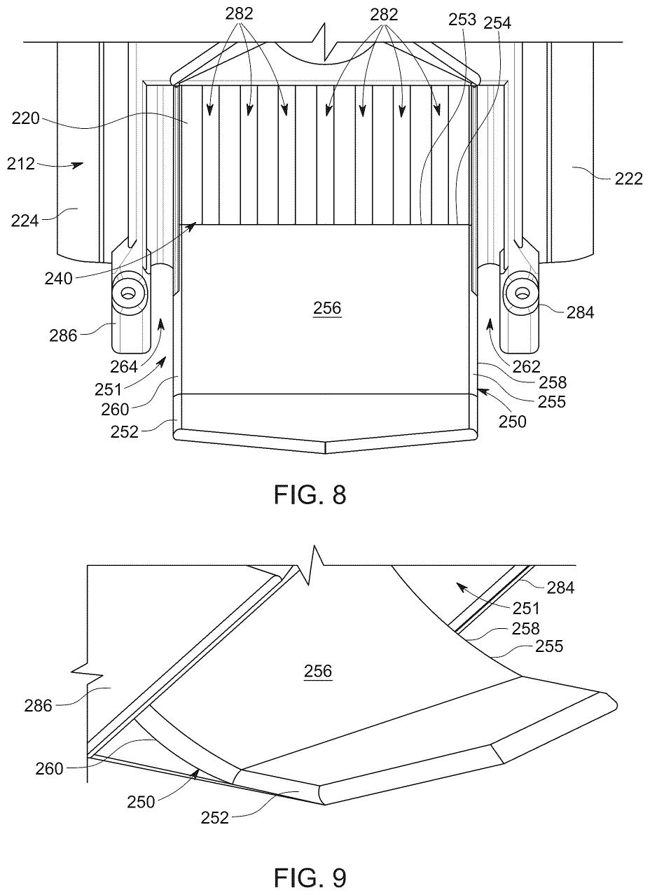

Moreover, the base 220 defines a plurality of openings 282 to enable a removal of dirt from the chamber 236. It may be noted that size of the openings 282 is selected such that the openings 282 allow exit of the dirt from the chamber 236, while preventing any undesired removal of the casings from the chamber 236. Further, an entrance opening 240 of the chamber 236 is defined at the front end 214 of the bin structure 212 to allow an entry of the casings picked by the augers 206, 208 and the lip 250. Moreover, the collector 202 includes a pair of extender walls 284, 286 extending outwardly of the entrance opening 240 and from the bin structure 212, defining a gap 251 therebetween. As shown in FIGS. 8, 9 and 10, The lip 250 extends inside the gap 251 defined between the extender walls 284, 286 and is connected to base 220 and extends outwardly of the front end 214 of the bin structure 212. A rear end 253 of the lip 250 is arranged proximate to the front end 214 of the bin structure, while a tip portion 252 of the lip 350 is arranged distally from the front end 214 of the bin structure 212 and outwardly of the extender walls 284, 286. A rear edge 254 of the lip 250 is arranged upwardly and rearwardly of the tip portion 252 of the lip 250. As shown, the lip 250 includes a curved portion 255 having a curved surface extending from the tip portion 252 to the rear edge 254. As shown in FIG. 8, the tip portion 252 includes a substantially V-shape. The tip portion 252 is adapted to scrape along the surface to enable a picking of the casings from the surface, while the curved surface 256 enables lifting and transport of the casings to the chamber 236 through the entrance opening 240.

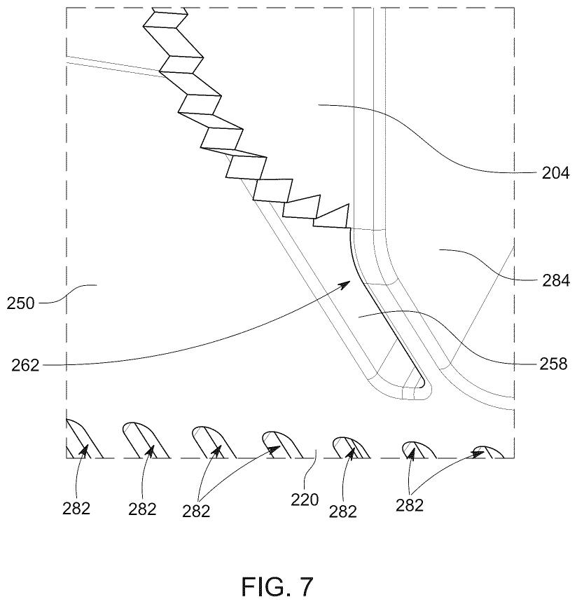

Moreover, the lip 250 includes a pair of sides 258, 260 extending in the longitudinal direction and arranged at an offset from the pair of extender walls 284, 286. Accordingly, as shown in FIG. 8, a first space 262 is defined between a first extender wall 284 and a first side 258 of the lip 250, and a second space 264 is defined between a second extender wall 286 of the pair of extender walls 284, 286 and a second side 260 of the lip 250. The wheels 204 are arranged inside the spaces 262, 264 and are rotatably connected to the pair of extender walls 284, 286 via at least one shaft. Accordingly, as best shown in FIG. 7, one wheel 204 is arranged between the first extender wall 284 and the lip 250 in the lateral direction, while another wheel 286 is arranged between the second extender wall 286 and the lip 250 in the lateral direction.

The two augers 206, 208 are connected to the wheels 204 and are arranged rotate in response to the rotation of the wheels 204. In the illustrated embodiment, a first auger 206 is connected to the one wheel 204 and a second auger 208 connected to the second wheel 204. The augers 206, 208 are arranged side by side in the lateral direction, and are disposed between the two wheels 204 such rotational axes of the augers 206, 208 align i.e., coincide with rotational axes of the wheels 204. In the illustrated embodiment, the augers 206, 208 are arranged such that a portion of each of the augers 206, 208 extends forwardly of tip portion 252 of the lip 250.

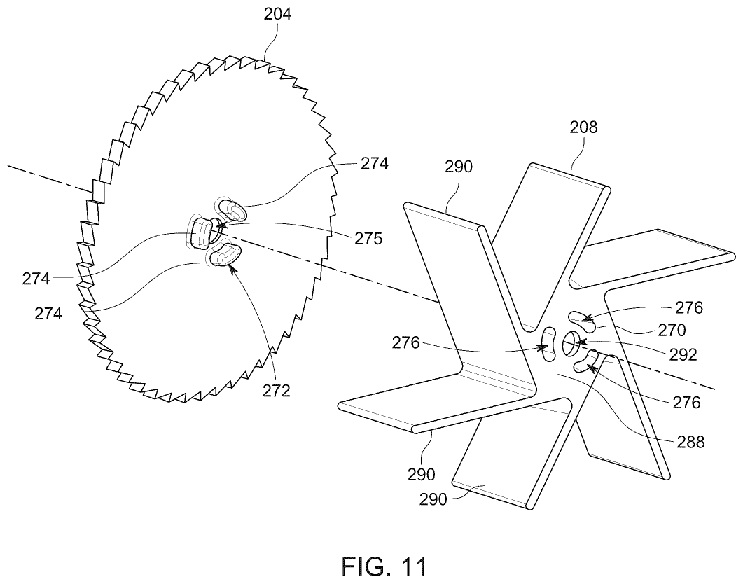

Referring to FIG. 11, to facilitate the connection of the augers 206, 208 with wheels 204, each of the auger 206, 208 includes a retention structure 270, while each of the wheels 204 includes an engagement structure 272 adapted to engage with the retention structure 270 of the associated auger 207, 208. In the illustrated embodiment, the engagement structure 272 includes a plurality of protrusions 274 arranged substantially centrally to the wheel 204 and arrayed circularly around the rotational axis of the wheel 204 with a central hole 275 arranged between the protrusions 274. The central hole 275 enables the rotatable connection of the wheel 204 with the associated extender wall, for example, the extender wall 286 vis a shaft.

To receive the plurality of protrusions 274, the retention structure 270 includes a plurality of slots 276 arrayed around the rotational axis of the associated auger, for example the auger 208. As shown, each of the augers 206, 208 includes a central hub 288 and a plurality of blades 290 arrayed around a circumference of the hub 288 and extending outwardly from an outer surface of the hub 288. Each blade extends in the lateral direction and is arranged spirally on the outer surface of the hub 288. Size of the blades 290 is selected such that the tips of the blades 290 are arranged to be proximate to the curved surface 256 of the lip 250 to move the picked casings along the curved surface 256 as the augers 206, 208 are rotated. Moreover, the hub 288 defines a central hole 292 that enables the rotatable coupling of the corresponding auger, for example, auger 208, with the extender wall 286. Accordingly, the augers 206, 208 rotates relative to the collector as the wheels 204 rotates due to the pulling of the collector device 200 on the surface.

Further, referring back to FIGS. 5 and 6, the collector 200 includes a handle engagement structure 242 connected to the bin structure 212 and arranged proximate to the front end 214 of the bin structure 212. As shown, the handle engagement structure 242 includes a tube portion 244 configured to removably receive the handle 210. The tube portion 244 may be pivotally connected to the bin structure 212 and is adapted to pivot about at least one axis relative to the bin structure 212. In some embodiments, the tube portion 244 is integrated to the bin structure 212 and extends vertically upwardly and obliquely in a forward direction i.e., towards the extender walls 284, 286 from the bin structure 212. Moreover, the bin structure 212 includes a pair of fingers 294 arranged proximate to the rear end 216 of the bin structure 212 and protruding outwardly of the bin structure 212 from the sidewalls 222, 224. The fingers 294 are utilized to pry out buried casings out of the ground.

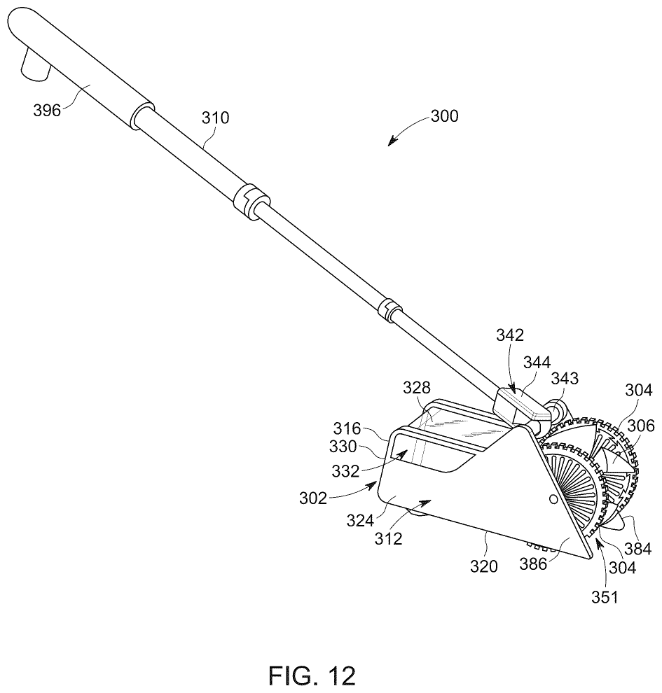

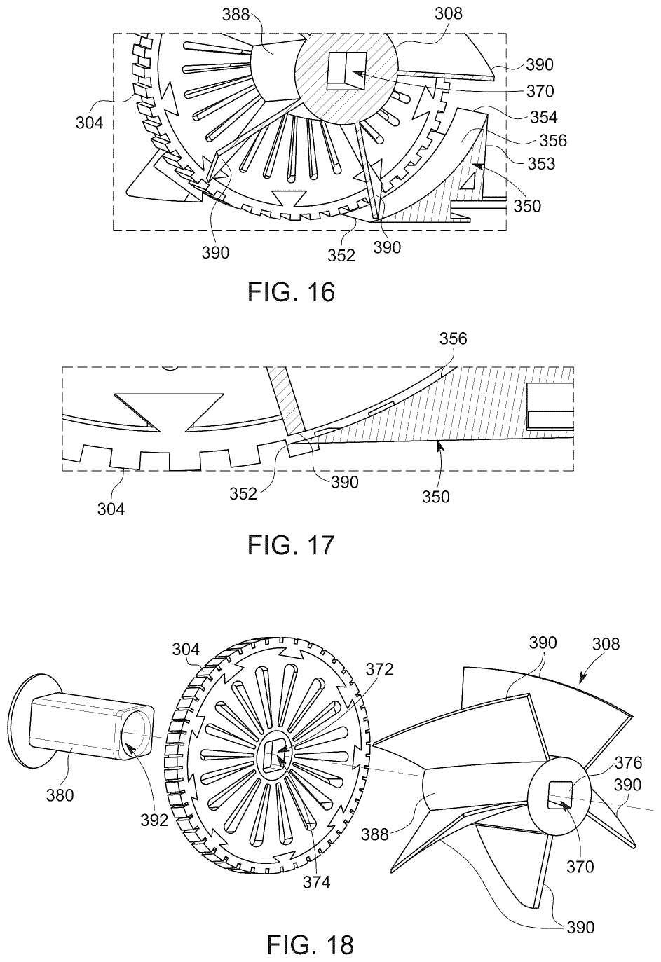

Referring to FIGS. 12-21, a collector device 300 is shown according to yet another embodiment of the disclosure. The collector device 300 is suitable to be used at an indoor location, and includes a collector 302, a handle 310 removable coupled to the collector 302 to enable a user to operate the collector device 300, a pair of wheels 304 rotatably coupled to the collector 302 to movably support the collector 302 on the surface, and at least one auger, for example, two augers 306, 308, coupled to the pair of wheels 304 and the collector 302 to pick and move the casings from the surface to the collector 302.

As shown, the collector 302 includes a bin structure 312 defining a chamber 336 to store the casings picked up from the surface, and a lip 350 coupled to the bin structure 312 to facilitate the picking and transport of the casings inside the bin structure 312 from the surface. The bin structure 312 includes a first end 314, i.e., front end 314, a second end 316 i.e., a rear end 316 arranged opposite to the front end 316, a base 320 extending from the front end 314 to the rear end 316, and a pair of sidewalls 322, 324 extending vertically from the base 320 and arranged spaced apart and opposite to each other. The sidewalls 322, 324 extend from the from end 314 to the rear end 316 in a longitudinal direction.

Further, the bin structure 312 includes a rear wall 330 arranged at the rear end 316 and extending vertically from the base 320. As shown, the rear wall 330 extends in a lateral direction, connecting the pair of sidewalls 322, 324. A lid 328 or roof may be fixedly or removably arranged on the upper ends of the sidewalls 322, 324 and the rear wall 330, covering a top opening of the chamber 336. One of the sidewalls 322, 324, for example, the second sidewall 324 defines an opening 332 arranged between the lid 328 and a portion of the upper end of the second sidewall 324 to facilitate a removal of the casings from the chamber 336. The casings may be removed from the chamber 336 through the opening 332 by tilting the bin structure 312 i.e., collector 302.

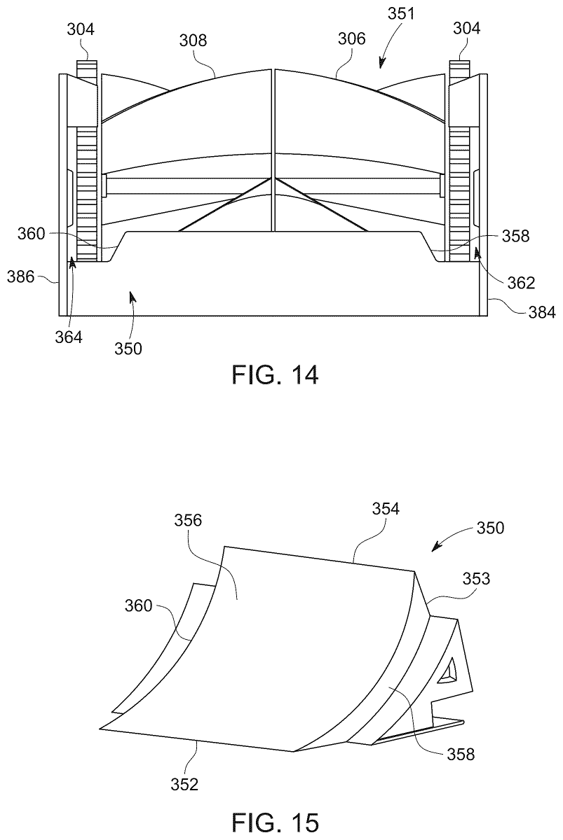

Further, an entrance opening 340 of the chamber 336 is defined at the front end 314 of the bin structure 312 to allow an entry of the casings picked by the augers 306, 308 and the lip 350. Moreover, the collector 302 includes a pair of extender walls 384, 386 extending forwardly i.e., outwardly in the longitudinal direction of the entrance opening 340 defining a gap 351 therebetween. As shown in FIG. 14, the lip 350 is arranged inside the gap 351 is connected to the base 320 i.e., bin structure 312 and extends forwardly and downwardly from the base 320. Accordingly, a rear end 353 of the lip 350 is connected to the base 320, while a tip portion 352 of the lip 350 is arranged distally from the base 320. A rear edge 354 of the lip 250 is arranged upwardly and rearwardly of the tip portion 252 of the lip 250.

As shown in FIGS. 15 to 17, the lip 350 includes an arch shape having a curved surface 356 along which the casings are moved by the augers 306, 308. The tip portion 352 of the lip 350 is adapted to scrape along the surface to enable a picking of the casings with the help of the augers 306, 308, while the curved surface 356 enables transporting of the casings to the chamber 336 through the entrance opening 340. In some embodiments, as shown, the tip 352 of the lip is arranged at vertical gap from the surface when the collector device 300 is moved on the surface with wheels 306 contacting the surface.

Moreover, as shown in FIG. 14, the sides 358, 360 of the curved surface 356 are arranged laterally offset from the pair of extender walls 384, 386. Accordingly, a first space 362 is defined between a first extender wall 384 and a first side 358, and a second space 364 is defined between a second extender wall 386 of the pair of extender walls 384, 386 and a second side 360. The wheels 304 are arranged inside the spaces 362, 364 and are rotatably connected to the pair of extender walls 384, 386 via suitable at least one shaft. The wheels 304 are connected to the augers 306, 308 and arranged to rotate with the wheels 304 in response to the rotation of the wheels 304.

As shown in FIGS. 12 to 14, the two augers 306, 308 are arranged between the two wheels 304, in the lateral direction, such rotational axes of the augers 306, 308 align i.e., coincide with rotational axes of the wheels 304. In the illustrated embodiment, the augers 306, 308 are arranged such that a portion of each of the augers 306, 308 extends forwardly of the tip portion 352 of the lip 350. To facilitate the connection of the augers 306, 308 with the wheels 304, referring to FIG. 18, each of the augers 306, 308 includes a retention structure 370, while each of the wheels 304 includes an engagement structure 372. In the illustrated embodiment, the engagement structure 372 includes a central square hole 374 (first square hole 374) having an axis aligned the rotational axis of the wheel 306, and the retention structure 370 includes a central square hole 376 (second square hole 376) extending in the lateral direction align with rotational axis of the associated one of the augers 306, 308.

One pin 380 having an outer shape of a square is configured to extend through the aligned holes 376, 378 one of the wheels 304 and one of the augers 306, 308 to couple one wheel 304 with one of the augers 306, 308. Similarly, another pin 380 having an outer shape of a square is configured to extend through the aligned holes 376, 378 another of the wheels 304 and another of the augers 308 to couple another wheel 304 with another of the augers 306, 308. The outer square shape of the pins 380 together with central square holes 376, 378 of the wheels 304 and the augers 306, 308 enable non-rotatable engagement of the wheels 304 with the augers 306, 308. Also, each pin 380 includes a central circular hole 392 through which the shaft connecting the wheel 306 to corresponding one of the extender walls 384, 386 extends. Accordingly, the circular hole 392 enables the rotation of an assembly of the auger and the wheel as a single unit around the shaft. Further, each of the augers 306, 308 includes a central hub 388 and a plurality of blades 390 arrayed around a circumference of the hub 388 and extending outwardly from an outer surface of the hub 388. The central square holes 376 extends through the hub 388. Each blade 390 extends in the lateral direction and is arranged spirally on the outer surface of the hub 388. Size of the blades 390 is selected such that the tips of the blades 390 are arranged to be proximate to the curved surface 356 of the lip 350 to move the picked casings along the curved surface 356 as the augers 306, 308 are rotated.

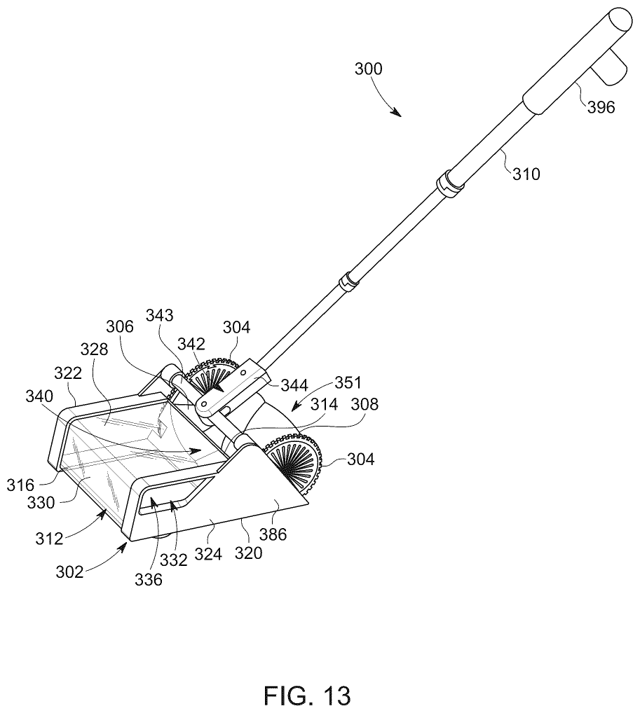

Further, referring back to FIGS. 12 and 13, the collector 302 includes a handle engagement structure 342 connected to the bin structure 312 and arranged proximate to the front end 314 of the bin structure 312. As shown, the handle engagement structure 312 includes a rod 343 extending in the lateral direction and above the lid 328. The ends of the rod 305 is connected to the sidewalls 322, 324 of the bin structure 312. Moreover, the handle engagement structure 342 includes a tube portion 344 configured to removably receive the handle 310. The tube portion 342 may be pivotally connected to the rod 343 and is adapted to pivot about at least one axis, for example, a first axis and a second axis extending substantially perpendicularly to the first axis, relative to the bin structure 312. Further, the handle 310 is a telescopic handle with a gun shaped grip 396 to an enable an easy handling of the collector device 300.

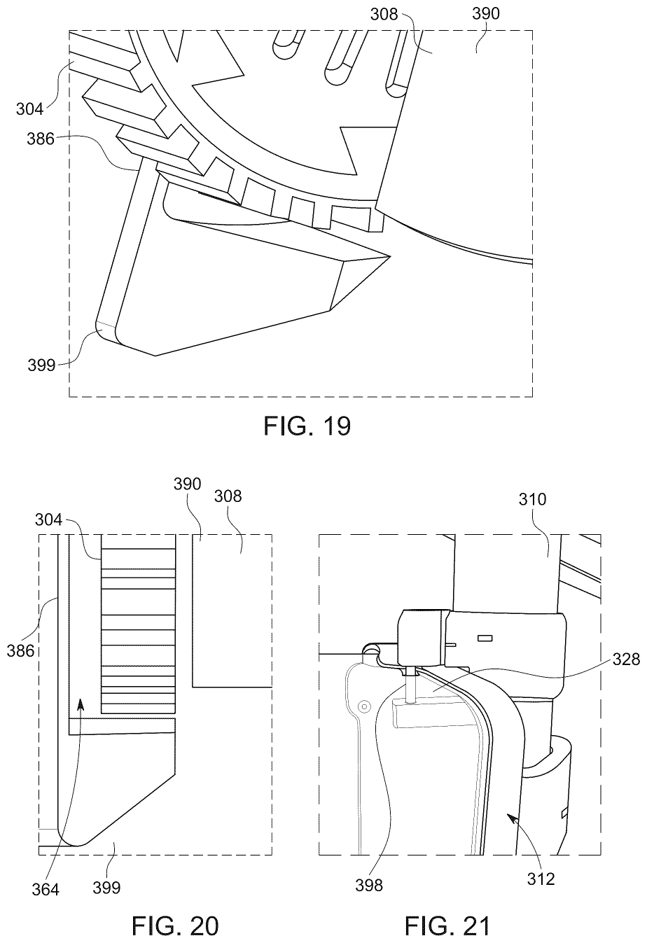

Moreover, referring to FIG. 21, the handle 300 includes a pin structure 398 that is arranged be extended inside a groove of the lid 328 or the tube portion 344 when the handle 310 is retracted to lock the handle 310 in the retracted position and enables an easy packaging and transportation of the collector device 300. Moreover, in some embodiments, as shown in FIGS. 19 and 20, the collector 302 includes a pair of projection tabs 399 attached to free ends of the pair of extender walls 384, 386. The projection tabs 399 extend at an angle and sits just in front of the associated wheel 304, and diverts object, such as, a casing, that get caught under the wheel 306 into the paths of the augers 306, 308.

A working of the collector device 100, 200, 300 is now described. To pick and collect the casings from the surface, the collector device 100, 200, 300 is positioned on the ground such that the first end 114, 214, 314 of the bin structure 112, 212, 312 is arranged vertically below the second end 116, 216, 316 of the bin structure 112, 212, 312. Accordingly, the base 120, 220, 320 is arranged at an inclination with the tip portion 152, 252, 352 of the lip 150, 250, 350 being arranged proximate to the surface/ground. In some embodiments, for example, for the collector device 100, 200, the tip portion 152, 252 may extend inside the surface, for example, when the surface is sand surface. In the indoor application, for example, for the collector device 300, the tip portion 352 may be arranged at a vertical gap from the surface to prevent any damage to the tip portion 352 that may occur due to contact with the hard surface.

Upon suitable positioning the collector device 100, 200, 300 on the surface, the collector device 100, 200, 300 is pushed/pulled along the surface by a user by holding the handle 110, 210, 310. As the collector device 100, 200, 300 is moved along the surface, the tip portion 152, 252, 352 of the lip 150, 250, 350 contacts the casings arranged on or embedded inside the surface, and picks up the casings from the surface. Moreover, due to the movement of the collector device 100, 200, 300 along the surface, the wheels 104, 204, 304 rotate relative to the bin structure 112, 212, 312, causing the rotation of the augers 106, 108, 206, 208, 306, 308. Rotating blades 190, 290, 390 of the augers 106, 108, 206, 208, 306, 308 move/push the picked casings along the curved surface 156, 256, 356 of the lip 150, 250, 350 and transport the casings inside the chamber 136, 236, 336 of the bin structure 112, 212, 312 through the entrance opening 140, 240, 340 of the bin structure 112, 212, 312.

In this manner, the collector device 100, 200, 300 collects the casings from the ground/surface easily and efficiently. Moreover, any dirt or the sand, picked up by the lip 150, 250 and transported to the chamber 140, 240 of the bin structure 112, 212 exit the chamber 140, 240 through the openings 182, 282 of the base 120, 220 of the bin structure 112, 212. Further, upon collecting the casings, the user tilts the collector device 100, 200, 300 relative to the surface/ground using the handle 110, 210, 310 to enable exit of the casings through the opening 132, 232, 332 of the bin structure 112, 212, 312 and collected inside a suitable bag.

It should be understood that the foregoing description is only illustrative of the aspects of the disclosed embodiments. Various alternatives and modifications can be devised by those skilled in the art without departing from the aspects of the disclosed embodiments

1. A collector device for picking and collecting cartridge shell casings from a surface, the collector device comprising:
a bin structure defining a chamber for storing the cartridge shell casings with an entrance opening defined at a first end for receiving the cartridge shell casings picked from the surface;
a lip coupled to the bin structure and extending outwardly from the entrance opening and configured to pick the cartridge shell casings from the surface;
a pair of wheels movably coupled to the bin structure to support and move the bin structure on the surface; and
at least one auger coupled to the wheels and arranged to rotate in response to the rotation of the wheels on the surface, wherein the at least one auger partially overlaps the lip and configured to push the cartridge shell casings, picked by the lip, inside the bin structure.

2. The collector device of claim 1, wherein the bin structure defines an opening arranged proximate to a second end of the bin structure to enable a removal of the cartridge shell casings from the chamber.

3. The collector device of claim 2, wherein the opening is defined between a sidewall of the bin structure and a lid of the bin structure arranged to cover the chamber from top.

4. The collector device of claim 2, wherein the opening is defined between a rear wall of the bin structure and a lid of the bin structure arranged to cover the chamber from top.

5. The collector device of claim 1, wherein the bin structure includes a base defining a plurality of openings to enable a removal of the dirt from the chamber.

6. The collector device of claim 1 further including a pair of extender walls extending outwardly of the first end of the bin structure, wherein the lip is arranged between the extender walls and the pair of wheels are rotatably coupled to extender walls.

7. The collector device of claim 6 further comprises a pair of protrusion tabs arranged forwardly of the pair of wheels and connected to the pair of extender walls.

8. The collector device of claim 1, wherein the lip includes a tip portion adapted to contact and lift the cartridge shell casings, and a curved surface to facilitate the at least one auger to transport the picked cartridge shell casings to the chamber.

9. The collector device of claim 1, wherein the bin structure includes a rear wall arranged opposite to the entrance opening and defining a chute to facilitate a removal of the collected cartridge shell casings from the chamber.

10. The collector device of claim 1, wherein the at least one auger includes a pair of augers engaged to the pair of wheels.

11. The collector device of claim 10, wherein
each of the pair of wheels includes an engagement structure, and
each of the pair of augers includes a retention structure engaged with the engagement structure, coupling the pair of augers with the pair of wheels.

12. The collector device of claim 11, wherein the engagement structure includes a plurality of protrusions and the retention structure includes a plurality of slots to receive the plurality of protrusions.

13. The collector device of claim 11, wherein the engagement structure includes a first square hole and the retention structure includes a second square hole arranged aligned with the first square hole and a pin extends inside the aligned first and second square holes, engaging the wheel with the auger.

14. The collector device of claim 1 further comprises a handle coupled to the bin structure to enable a user to hold the collector device and move the collector device on the surface to pick the cartridge shell casings from the surface.

15. The collector device of claim 14 further comprises a handle engagement structure attached to the bin structure, wherein the handle is removably engaged to the handle engagement structure.

16. The collector device of claim 15, wherein the handle engagement structure includes a tube portion coupled to the bin structure to removably receive the handle.

17. The collector device of claim 15, wherein the handle engagement structure includes a rod attached to the bin structure and the tube portion is pivotally engaged with the rod and configured to pivot about at least one axis relative to the rod.

18. The collector device of claim 17 wherein the at least one axis includes a first axis and a second axis extending perpendicularly to the first axis.

19. The collector device of claim 14, wherein the handle is a telescopic handle and includes a pin structure adapted to be inserted inside a lid of the bin structure to secure the handle in a retracted position.

20. The collector device of claim 1, wherein the bin structure includes a pair of sidewalls and a pair of fingers extending outwardly of the chamber in the lateral direction to pry out buried cartridge shell casings.
